(19) United States
(12) Patent Application Publication
(10) Pub. No.: US 2019/0001497 A1
(43) Pub. Date: Jan. 3, 2019

(54) ROBOTIC SYSTEM AND METHOD OF ASSEMBLING AN APPARATUS

(71) Applicant: Honda Motor Co., Ltd., Tokyo (JP)

(72) Inventors: Kristopher Ryann Lelliott, Barrie (CA); Darryl James Galloway, Rosemont (CA)

(21) Appl. No.: 15/635,611

(22) Filed: Jun. 28, 2017

(51) Int. Cl. B25J 9/16; G05B 19/418

(52) U.S. Cl. CPC B25J 9/1687; G05B 19/4183; G05B 2219/45066; G05B 2219/45064; G05B 2219/45061; Y10S 901/44

(57) ABSTRACT

A method of assembling an apparatus. The method includes configuring a robotic device to operate in a first mode of a plurality of modes, wherein the robotic device is positionable to inspect a predetermined feature on a first component when in the first mode. The method also includes determining an expected value for a measurable parameter of the predetermined feature when inspected by the robotic device, wherein the expected value is determined based on which of the plurality of modes the robotic device is operating. The method further includes directing the robotic device to inspect the first component to determine an actual value for the measurable parameter, and verifying an identity of the first component based on a comparison between the expected value and the actual value.

### BACKGROUND

The field of the present disclosure relates generally to a robotic manufacturing system and, more specifically, to a detection and part identity assurance system for use in a secondary assembly operation.

In at least some known conventional assembly lines, and automotive assembly lines in particular, a continuous feed of partially completed assemblies is channeled through a plurality of assembly stations to form an assembly. At least some known components used in the assembly may be pre-assembled away from the assembly line, and then transferred to the assembly line for installation in the assembly. At the pre-assembly station, at least some known systems implement a robotic device capable of performing an assembly operation for different models of the same type of part. For example, in at least some known systems, a part is loaded into the pre-assembly station, and the robotic device implements one of several predetermined programs for performing the assembly operation for a particular part. To ensure the robotic device is set to the correct program for the part loaded in the off-line assembly station, at least some known systems include a plurality of sensors on a jig that holds the part in position. The sensors cause the robotic device to implement the correct program to assemble the part on the jig. However, coupling a plurality of sensors on the jig may be costly, may be difficult to maintain, and may be susceptible to damage.

### BRIEF DESCRIPTION

In one aspect, a method of assembling an apparatus is provided. The method includes configuring a robotic device to operate in a first mode of a plurality of modes, wherein the robotic device is positionable to inspect a predetermined feature on a first component when in the first mode. The method also includes determining an expected value for a measurable parameter of the predetermined feature when inspected by the robotic device, wherein the expected value is determined based on which of the plurality of modes the robotic device is operating. The method further includes directing the robotic device to inspect the first component to determine an actual value for the measurable parameter, and verifying an identity of the first component based on a comparison between the expected value and the actual value.

In another aspect, a robotic system for use in assembling an apparatus is provided. The robotic system includes a robotic device operable between a plurality of modes, wherein said robotic device comprises an inspection device coupled thereto. A controller is in communication with the robotic device, and the controller is configured to configure the robotic device to operate in a first mode of the plurality of modes, wherein said robotic device is positionable to inspect a predetermined feature on a first component when in the first mode. The controller is further configured to determine an expected value for a measurable parameter of the predetermined feature when inspected by the robotic device, wherein the expected value is determined based on which of the plurality of modes the robotic device is operating. Controller also directs the robotic device to inspect the first component with the inspection device to determine an actual value for the measurable parameter, and verifies an identity of the first component based on a comparison between the expected value and the actual value.

### BRIEF DESCRIPTION OF THE DRAWINGS

FIG. 1 is a schematic illustration of an exemplary robotic system that may be used to perform an assembly operation; and

FIG. 2 is a flow diagram illustrating an exemplary control logic for a controller that may be used with the robotic system shown in FIG. 1.

### DETAILED DESCRIPTION

The embodiments described herein relate generally to a detection and part identity assurance system for use in a secondary assembly operation, which may be performed off-line from a primary assembly line. More specifically, the system described herein includes a robotic device having an inspection tool coupled thereto, wherein the robotic device is programmed to operate in a plurality of modes. The mode in which the robotic device is configured to operate is based on a model type of a part to be worked on by the robotic device. For example, the robotic device may inspect and perform an assembly operation on different models of the same part, wherein the different models are unique from each other in at least one predetermined feature. In operation, a part is loaded in a predetermined position relative to the robotic device, and the robotic device is programmed to inspect the unique predetermined feature on the part when operating in a particular mode for the part model. The inspection is used to verify an identity of the part, and to verify that the robotic device is in the correct mode for subsequently performing an assembly operation for the part. As such, the system and methods described herein facilitate enabling the robotic device to perform the correct assembly operation in a reliable and simplified manner on a plurality of different components.

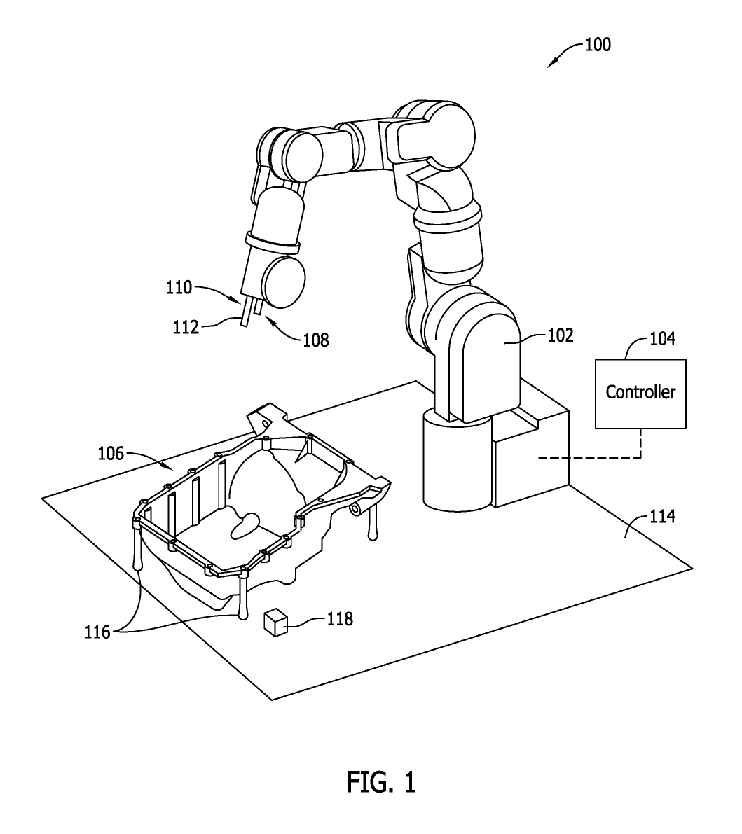

FIG. 1 is a schematic illustration of an exemplary robotic system 100 that may be used to perform an assembly operation. In the exemplary embodiment, robotic system 100 includes a robotic device 102 and a controller 104 in communication with robotic device 102. Robotic device 102 is operable to inspect and perform an assembly operation for a component 106, and controller 104 controls operation of robotic device 102, as will be explained in further detail below. As shown, component 106 is an oil pan for an automobile. However, it should be understood that robotic system 100 may be used to perform an assembly operation on components other than an oil pan.

In the exemplary embodiment, robotic device 102 includes an inspection device 108 coupled thereto. Inspection device 108 is any non-contact sensor capable of determining a measurable parameter on, or for, component 106. Example, inspection devices include, but are not limited to, a laser range finder, an ultrasonic sensor, and a light reflectance sensor. In addition, robotic device 102 includes an assembly tool 110 coupled thereto. Assembly tool 110 is any tool or device capable of performing an assembly operation for an apparatus including component 106. In the exemplary embodiment, assembly tool 110 is a sealant applicator device 112 capable of applying sealant to component 106 as robotic device 102 traverses component 106 in accordance with a predetermined tool path, for example.

In some embodiments, robotic system 100 further includes a mounting surface 114 that receives component 106 thereon, and a plurality of mounting members 116 extending from mounting surface 114. Mounting members 116 are arranged on mounting surface 114 such that component 106 is mounted thereon in a predetermined position relative to robotic device 102. Moreover, in one embodiment, the different models of component 106 are mountable on mounting surface 114 using the same arrangement of mounting members 116. As such, as will be explained in more detail below, robotic device 102 is capable of determining the measurable parameter when at a predetermined inspection position relative to component 106.

Robotic system 100 further includes a proximity sensor 118 on mounting surface 114. Proximity sensor 118 is in communication with controller 104, and is operable to verify that component 106 is mounted in the predetermined position before robotic device 102 is directed to inspect component 106. If component 106 is not mounted in the predetermined position, an alert is provided and controller 104 prevents robotic device 102 from executing an inspection program. If component 106 is mounted correctly in the predetermined position, controller 104 directs robotic device 102 to execute the inspection program to determine the measurable parameter. As such, proximity sensor 118 facilitates ensuring robotic device 102 determines the measurable parameter in an accurate and reproducible manner. In one embodiment, proximity sensor 118 is any non-contact sensor that enables robotic system 100 to function as described herein.

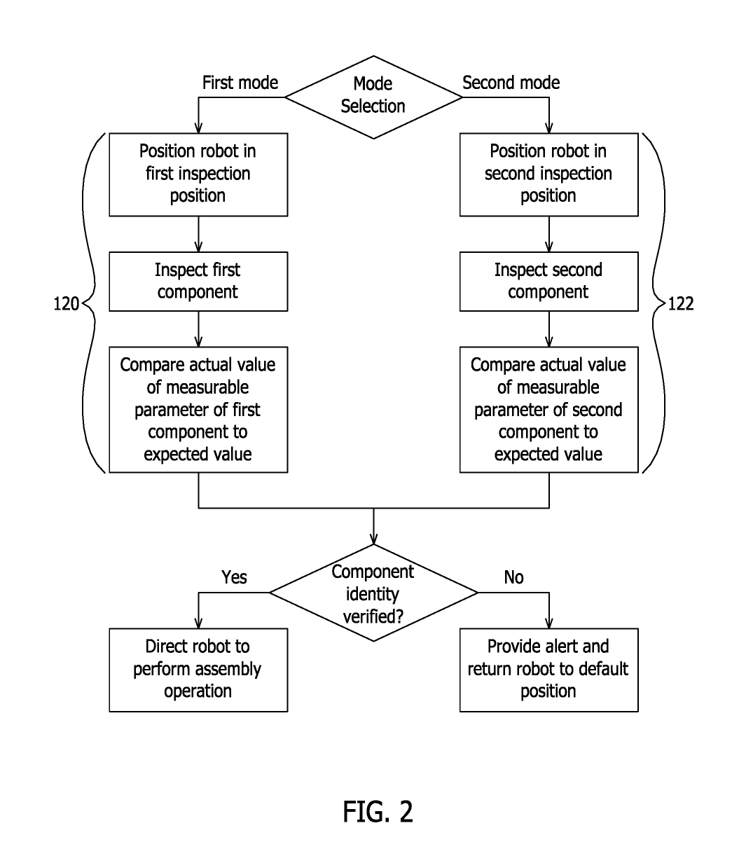

FIG. 2 is a flow diagram illustrating an exemplary control logic for controller 104 that may be used in robotic system 100 (both shown in FIG. 1). In the exemplary embodiment, robotic device 102 selectively operates in one of a plurality of modes. Each mode corresponds to a different model of component 106 (shown in FIG. 1). The different models of component 106 differ from each other in at least one of overall shape or dimensionality such that each model has at least one unique predetermined feature. Example predetermined features include, but are not limited to, ridges, indentations, grooves, and/or raised features that are present in one model of component 106, but not present in a different model of component 106. As such, robotic device 102 is directed to inspect a different predetermined feature, and to subsequently perform a different assembly operation, based on the mode of operation in which robotic device 102 is operating.

In the exemplary embodiment, controller 104 directs robotic device 102 to execute a first program 120 when a first mode is selected, and directs robotic device 102 to execute a second program 122 when a second mode is selected. For example, robotic device 102 is positionable in a first inspection position to inspect a predetermined feature on a first component (i.e., a first model of component 106) when first program 120 is executed, and robotic device 102 is positionable in a second inspection position to inspect a different predetermined feature on a second component (i.e., a second model of component 106) when second program 122 is executed. The first and second inspection positions may be the same position, or different positions, on the first and second components. When the first and second inspection positions are the same position, the expected value of the measurable parameter is different between the first and second components. In one embodiment, robotic device 102 receives a manual selection of one of the plurality of modes from a user. In an alternative embodiment, robotic device 102 is configured to operate between the plurality of modes based on a radio-frequency identification signal received from component 106.

After robotic device 102 is in the inspection position, controller 104 then directs robotic device 102 to inspect component 106 such that an actual value of the measurable parameter is determined. As noted above, in one embodiment, robotic device 102 includes a laser range finder coupled thereto as its inspection device 108. As such, robotic device 102 determines an actual value for a distance between inspection device 108 and the predetermined feature on component 106.

The actual value of the measurable parameter is then compared to an expected value of the measurable parameter. The expected value used in the comparison is determined based on which of the plurality of modes robotic device 102 is operating. For example, because robotic device 102 inspects a different predetermined feature on the different models of component 106, the expected value of the measurable parameter used to verify component 106 varies based on which of the plurality of modes robotic device 102 is operating. As such, the expected value of the measurable parameter of the first component is different from the expected value of the measurable parameter of the second component. In addition, the expected values for the plurality of modes are predetermined values that, in one embodiment, are stored in controller 104 for future reference when verifying component 106.

The identity of component 106 is verified based on the comparison between the actual value and the expected value of the measurable parameter. For example, if a difference between the actual value and the expected value is greater than a predetermined threshold, the identity of component 106 is not verified and a determination is made that the incorrect component is loaded on mounting surface 114 for the mode in which robotic device 102 is currently set. As such, in some embodiments, controller 104 then provides an alert and returns robotic device 102 to a default position from the predetermined inspection position. If the difference between the actual value and the expected value is less than the predetermined threshold, the identity of component 106 is verified and a determination is made that the correct component is loaded on mounting surface 114 for the mode in which robotic device 102 is currently set.

Controller 104 then directs robotic device 102 to perform an assembly operation on component 106. As noted above, the different models of component 106 differ from each other in at least one of overall shape or dimensionality. As such, the assembly operation is executed in accordance with a unique tool path associated with the mode in which robotic device 102 is operating, and the unique tool path corresponds to the shape and dimensions of the model of component 106 that has been verified. For example, in the exemplary embodiment, the unique tool path facilitates enabling robotic device 102 to apply sealant about a periphery of component 106 with sealant applicator device 112 (shown in FIG. 1).

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of assembling an apparatus, said method comprising:
configuring a robotic device to operate in a first mode of a plurality of modes, wherein the robotic device is positionable to inspect a predetermined feature on a first component when in the first mode;
determining an expected value for a measurable parameter of the predetermined feature when inspected by the robotic device, wherein the expected value is determined based on which of the plurality of modes the robotic device is operating;
directing the robotic device to inspect the first component to determine an actual value for the measurable parameter; and
verifying an identity of the first component based on a comparison between the expected value and the actual value.

2. The method in accordance with claim 1 further comprising directing the robotic device to perform an assembly operation after the identity of the first component has been verified.

3. The method in accordance with claim 1, wherein directing the robotic device to inspect the first component comprises directing the robotic device to inspect the first component using a non-contact inspection technique.

4. The method in accordance with claim 1, wherein directing the robotic device to inspect the first component comprises:
directing the robotic device to inspect the first component from a predetermined position relative to the first component; and
determining the actual value for the measurable parameter, wherein the measurable parameter is a distance between the robotic device and the predetermined feature on the first component.

5. The method in accordance with claim 1 further comprising providing an alert when a difference between the expected value and the actual value is greater than a predetermined threshold.

6. The method in accordance with claim 1, wherein configuring a robotic device comprises receiving a manual selection of one of the plurality of modes.

7. The method in accordance with claim 1 further comprising configuring the robotic device to operate in a second mode of the plurality of modes, wherein the robotic device is positionable to inspect a predetermined feature on a second component when in the second mode, and wherein the predetermined feature on the first component is different from the predetermined feature on the second component.

8. The method in accordance with claim 1 further comprising configuring the robotic device to operate in a second mode of the plurality of modes, wherein the robotic device is positionable to inspect a predetermined feature on a second component when in the second mode, and wherein the expected value of the measurable parameter of the first component is different from the expected value of the measurable parameter of the second component.

9. The method in accordance with claim 1, wherein the first component is mounted in a predetermined position relative to the robotic device, said method further comprising verifying the first component is mounted in the predetermined position before directing the robotic device to inspect the first component.

10. The method in accordance with claim 1 further comprising:
receiving the first component from a primary assembly line, wherein the robotic device is configured to inspect and perform an assembly operation on the first component; and
returning the first component to the primary assembly line after the inspection and the assembly operation has been executed.

11. A robotic system for use in assembling an apparatus, said robotic system comprising:
a robotic device operable between a plurality of modes, wherein said robotic device comprises an inspection device coupled thereto; and
a controller in communication with said robotic device, wherein said controller is configured to:
configure said robotic device to operate in a first mode of the plurality of modes, wherein said robotic device is positionable to inspect a predetermined feature on a first component when in the first mode;
determine an expected value for a measurable parameter of the predetermined feature when inspected by said robotic device, wherein the expected value is determined based on which of the plurality of modes said robotic device is operating;
direct said robotic device to inspect the first component with said inspection device to determine an actual value for the measurable parameter; and
verify an identity of the first component based on a comparison between the expected value and the actual value.

12. The robotic system in accordance with claim 11, wherein said robotic device further comprises an assembly tool configured to perform an assembly operation for the apparatus.

13. The robotic system in accordance with claim 12, wherein said controller is further configured to direct said robotic device to perform the assembly operation after the identity of the first component has been verified.

14. The robotic system in accordance with claim 11 further comprising:
a mounting surface configured to receive the first component thereon, wherein the first component is mounted on said mounting surface in a predetermined position relative to said robotic device; and
a proximity sensor in communication with said controller, wherein said proximity sensor is configured to verify the first component is mounted in the predetermined position before said robotic device is directed to inspect the first component.

15. The robotic system in accordance with claim 11, wherein said controller is further configured to provide an alert when a difference between the expected value and the actual value is greater than a predetermined threshold.

16. The robotic system in accordance with claim 11, wherein said controller is configured to direct said robotic device to inspect the first component, with said inspection device, using a non-contact inspection technique.

17. The robotic system in accordance with claim 16, wherein said inspection device is a non-contact sensor, and wherein the measurable parameter is a distance between the robotic device and the predetermined feature on the first component.

18. The robotic system in accordance with claim 11, wherein said controller is further configured to receive a manual selection of one of the plurality of modes.

19. The robotic system in accordance with claim 11, wherein said controller is further configured to configure said robotic device to operate in a second mode of the plurality of modes, wherein said robotic device is positionable to inspect a predetermined feature on a second component when in the second mode, and wherein the predetermined feature on the first component is different from the predetermined feature on the second component.

20. The robotic system in accordance with claim 11, wherein said controller is further configured to configure said robotic device to operate in a second mode of the plurality of modes, wherein said robotic device is positionable to inspect a predetermined feature on a second component when in the second mode, and wherein the expected value for the measurable parameter of the first component is different from the expected value of the measurable parameter of the second component.
